(19) United States
(12) Patent Application Publication
(10) Pub. No.: US 2025/0333040 A1
(43) Pub. Date: Oct. 30, 2025

(54) METHOD FOR OPERATING A MOTOR VEHICLE, DEVICE FOR OPERATING A MOTOR VEHICLE, MOTOR VEHICLE

(71) Applicant: Robert Bosch GmbH, Stuttgart (DE)

(72) Inventors: Florian Haag, Ellhofen (DE); Markus Schuster, Helmstadt (DE); Martin Marquart, Ludwigsburg (DE); Nikolas Loeffelmann, Dielheim (DE)

(21) Appl. No.: 18/866,596

(22) PCT Filed: May 25, 2023
(86) PCT No.: PCT/EP2023/064086

§ 371 Date: Nov. 18, 2024

(30) Foreign Application Priority Data
Jun. 8, 2022 (DE) 10 2022 205 826.7

(51) Int. Cl. B60T 17/10; B60T 17/22

(52) U.S. Cl. CPC B60T 17/10; B60T 17/221

(57) ABSTRACT

A method for operating a motor vehicle including a hydraulic brake system having at least one controllable first hydraulic actuator and one controllable second hydraulic actuator. According to an example embodiment of the present invention, the motor vehicle is decelerated according to a deceleration specification by controlling a selected one of the hydraulic actuators. A current wear condition of the first hydraulic actuator is ascertained, a current wear condition of the second hydraulic actuator is ascertained, and the selection of one of the hydraulic actuators is made according to the ascertained wear conditions.

### FIELD

The present invention relates to a method for operating a motor vehicle comprising a hydraulic brake system having at least one controllable first hydraulic actuator and one controllable second hydraulic actuator, wherein the motor vehicle is decelerated according to a deceleration specification by controlling a selected one of the hydraulic actuators.

The present invention also relates to a device for operating a motor vehicle comprising a hydraulic brake system having at least one controllable first hydraulic actuator and one controllable second hydraulic actuator.

Furthermore, the present invention relates to a motor vehicle comprising a hydraulic brake system having at least one controllable first hydraulic actuator and one controllable second hydraulic actuator.

### BACKGROUND INFORMATION

Methods and motor vehicles of the type mentioned above are described in the related art. A motor vehicle typically comprises a hydraulic brake system. Brake systems having at least one controllable first hydraulic actuator and one controllable second hydraulic actuator are described in the related art. In such brake systems, a friction braking torque that decelerates the motor vehicle can be generated both by controlling the first hydraulic actuator and by controlling the second hydraulic actuator. Typically, one of the hydraulic actuators is selected, i.e., the first hydraulic actuator or the second hydraulic actuator, wherein the selection of one of the hydraulic actuators can be made depending on the situation. If a deceleration specification is present for the motor vehicle, the motor vehicle is then decelerated by controlling the selected hydraulic actuator.

### SUMMARY

A method according to the present invention may have the advantage that a service life of the hydraulic actuators can be maximized. According to an example embodiment of the present invention, it is provided that a current wear condition of the first hydraulic actuator is ascertained, that a current wear condition of the second hydraulic actuator is ascertained, and that the selection of one of the hydraulic actuators is made depending on the ascertained wear conditions. The current wear conditions of the hydraulic actuators are thus taken into account when selecting one of the hydraulic actuators. By taking the current wear conditions into account, the further or future wear of the hydraulic actuators can be influenced. Preferably, the hydraulic actuator with the lower current wear condition is preferably or more frequently selected. This can reduce the further or future wear of the other hydraulic actuator. In particular, it is achieved that the first hydraulic actuator and the second hydraulic actuator wear at approximately the same rate over the service life of the motor vehicle so that the current wear condition of the first hydraulic actuator always corresponds at least substantially to the current wear condition of the second hydraulic actuator. Preferably, when selecting one of the hydraulic actuators, at least one further item of information is taken into account in addition to the wear conditions of the hydraulic actuators.

According to a preferred embodiment of the present invention, it is provided that the wear condition of at least one of the hydraulic actuators is ascertained depending on an ascertained load collective of the hydraulic actuator in question. If the wear condition of the first hydraulic actuator is ascertained, the ascertained load collective of the first hydraulic actuator is taken into account. If the wear condition of the second hydraulic actuator is ascertained, the ascertained load collective of the second hydraulic actuator is taken into account. Preferably, both the wear condition of the first hydraulic actuator and the wear condition of the second hydraulic actuator are ascertained depending on the ascertained load collective of the hydraulic actuator in question. On the basis of the previous load collective, the wear condition of the hydraulic actuator in question can be determined precisely. Preferably, the load collective describes the course of the load acting on the hydraulic actuator in question, in particular since the hydraulic actuator was first put into operation. Preferably, the load is ascertained depending on a hydraulic pressure of a hydraulic fluid of the brake system. Alternatively, the load is preferably ascertained depending on a motor current of an electric motor of the hydraulic actuator in question.

According to a preferred embodiment of the present invention, it is provided that a threshold load is specified, and that only loads exceeding the threshold load are taken into account when ascertaining the load collective. This is based on the finding that the wear condition of the hydraulic actuators is hardly affected by low loads below the threshold load. As previously mentioned, the wear conditions of both hydraulic actuators are preferably ascertained depending on the ascertained load collective of the hydraulic actuator in question. In particular, the same threshold load is specified for the first hydraulic actuator and the second hydraulic actuator. Alternatively, a different threshold load is specified for the first hydraulic actuator than for the second hydraulic actuator.

According to a preferred embodiment of the present invention, it is provided that a plurality of load ranges is defined, and that, when ascertaining the load collective, occurring loads are weighted differently depending on their belonging to one of the load ranges. This is based on the finding that the wear condition of the hydraulic actuators is influenced to different degrees by different loads. Preferably, when ascertaining the load collective, a high load is weighted more strongly than a low load.

According to a preferred embodiment of the present invention, it is provided that a maximum load collective is specified, and that the wear condition is ascertained depending on a deviation of the ascertained load collective from the maximum load collective. By specifying the maximum load collective, a reference value for the ascertained load collective is advantageously defined so that it is possible to precisely ascertain the current wear condition. As previously mentioned, the current wear conditions of both hydraulic actuators are preferably ascertained depending on an ascertained load collective of the hydraulic actuator in question. Preferably, a different maximum load collective is specified for each hydraulic actuator.

Preferably, according to an example embodiment of the present invention, the selection of one of the hydraulic actuators is made depending on a target pressure build-up dynamics of the deceleration specification. When selecting one of the hydraulic actuators, the target pressure build-up dynamics of the deceleration specification is thus taken into account in addition to the current wear conditions. Typically, hydraulic actuators differ in their maximum pressure build-up dynamics. Preferably, if a target pressure build-up dynamics exceeds a threshold pressure build-up dynamics, the hydraulic actuator with the higher maximum pressure build-up dynamics is always selected. If the other hydraulic actuator were selected, the resulting pressure build-up dynamics might be undesirably low.

According to a preferred example embodiment of the present invention, it is provided that the functional readiness of the hydraulic actuators is checked, and that the selection of one of the hydraulic actuators is made depending on the functional readiness of the hydraulic actuators. If, for example, there is information for one of the hydraulic actuators that the functional readiness of the hydraulic actuator is limited, the other hydraulic actuator is preferably always selected regardless of the current wear conditions of the hydraulic actuators.

According to an example embodiment of the present invention, preferably, the selection of one of the hydraulic actuators is made depending on a noise level in the passenger region of the motor vehicle. Typically, one of the hydraulic actuators generates less noise than the other of the hydraulic actuators at the same volumetric delivery rate. Preferably, if a noise level falls below a threshold noise level, the hydraulic actuator that generates less noise is always selected regardless of the current wear conditions of the hydraulic actuators. For passengers in the motor vehicle, this is particularly comfortable with regard to disturbing noises being produced. Preferably, the noise level in the passenger region of the motor vehicle is detected, for example by a microphone. Alternatively, a variable corresponding to the noise level in the passenger region is preferably detected and the noise level in the passenger region is estimated depending on the detected variable. For example, the driving speed of the motor vehicle is detected as the variable.

According to a preferred example embodiment of the present invention, it is provided that the selection of one of the hydraulic actuators is made depending on a detected actual temperature. This is based on the finding that the use of one of the hydraulic actuators can be more critical at low temperatures than the use of the other hydraulic actuator. Accordingly, if the actual temperature is low, for example if the actual temperature falls below a threshold temperature, the other hydraulic actuator is preferably selected. For example, the ambient temperature is detected as the actual temperature.

According to a preferred example embodiment of the present invention, it is provided that the selection of one of the hydraulic actuators is made depending on a specified target load ratio, wherein the target load ratio describes a load to be applied by the first hydraulic actuator relative to a load to be applied by the second hydraulic actuator, and that the target load ratio is specified depending on the ascertained wear conditions. This allows a desired distribution of the braking load to the hydraulic actuators to be adjusted dynamically. If, for example, the first hydraulic actuator has greater wear than the second hydraulic actuator, the target load ratio is preferably changed such that the load to be applied by the first hydraulic actuator in the future is reduced.

A device according to the present invention in that the device comprises at least one control unit and is specifically configured to carry out the method according to the present invention by means of the control unit when used as intended. This also results in the advantages mentioned above. Further preferred features and combinations of features result from what was described above and disclosed in the rest of disclosure herein.

According to a preferred embodiment of the present invention, it is provided that the device has a first control unit for controlling the first hydraulic actuator and a second control unit for controlling the second hydraulic actuator, wherein one of the control units is designed to select one of the hydraulic actuators and to provide the other control unit with information regarding the selected hydraulic actuator. An arbitrator logic for selecting one of the hydraulic actuators is thus implemented only in the one control unit. This prevents the two control units from selecting different hydraulic actuators.

The motor vehicle according to the present invention includes the device according to the present invention. This also results in the advantages mentioned above. Further preferred features and combinations of features result from what was described above and from the rest of the disclosure herein. The first hydraulic actuator is preferably designed to actuate a master brake cylinder of the brake system. The second hydraulic actuator is preferably a radial piston pump of a hydraulic block of the brake system. Preferably, a brake pedal of the brake system is mechanically and hydraulically decoupled from the master brake cylinder. There is thus no mechanical or hydraulic coupling that acts between the brake pedal and the master brake cylinder and would necessarily convert an actuation of the brake pedal into an actuation of the master brake cylinder. In a motor vehicle with such a brake system, carrying out the method according to the present invention is particularly advantageous. The pedal feel that a user experiences when actuating the brake pedal is in this case not affected by the selection of one of the hydraulic actuators.

The present invention is explained in more detail below with reference to the figures.

### BRIEF DESCRIPTION OF THE DRAWINGS

FIG. 1 shows a motor vehicle according to an example embodiment of the present invention in a schematic representation.

FIG. 2 shows a method for operating the motor vehicle, according to an example embodiment of the present invention.

### DETAILED DESCRIPTION OF EXAMPLE EMBODIMENTS

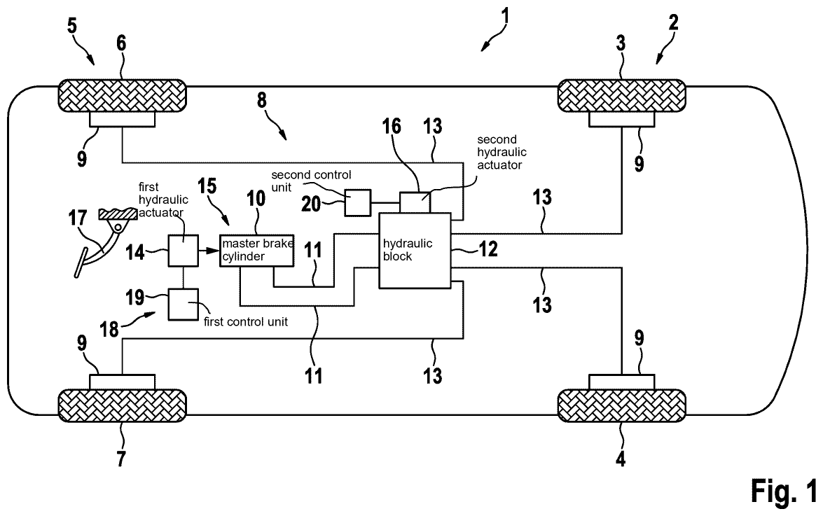

FIG. 1 shows a motor vehicle 1 in a schematic representation. The motor vehicle 1 has a front wheel axle 2 with two wheels 3 and 4 and a rear wheel axle 5 with two wheels 6 and 7. The motor vehicle 1 also has a hydraulic brake system 8. The brake system 8 has a plurality of friction brake devices 9. Each of the wheels 3, 4, 6 and 7 is assigned a different one of the friction brake devices 9.

The brake system 8 also has a master brake cylinder 10, which in the present case is designed as a tandem master brake cylinder 10. The master brake cylinder 10 is fluidly connected to a hydraulic block 12 of the brake system 8 by two first hydraulic lines 11. The hydraulic block 12 is fluidly connected to slave cylinders of the friction brake devices 9 by a plurality of second hydraulic lines 13. If the master brake cylinder 10 is actuated, a hydraulic fluid is moved through the hydraulic lines 11 and 13 into the slave cylinders of the friction brake devices 9 so that the friction brake devices 9 are actuated and generate a friction braking torque.

The brake system 8 has a controllable first hydraulic actuator 14. The first hydraulic actuator 14 is assigned to the master brake cylinder 10 and is designed to actuate the friction brake devices 9 by actuating the master brake cylinder 10. The first hydraulic actuator 14 and the master brake cylinder 10 together form a reciprocating piston pump 15. The brake system 8 also has a controllable second hydraulic actuator 16. The second hydraulic actuator 16 is also designed to actuate the friction brake devices 9 by increasing the hydraulic pressure of the hydraulic fluid. In the present case, the second hydraulic actuator 16 is a radial piston pump 16 integrated into the hydraulic block 12.

The brake system 8 also has a brake pedal 17 which can be actuated by a user of the motor vehicle 1. By actuating the brake pedal 17, the user can provide a deceleration specification for the motor vehicle 1. According to the exemplary embodiment shown in FIG. 1, the brake pedal 17 is mechanically and hydraulically decoupled from the master brake cylinder 10. Between the brake pedal 17 and the master brake cylinder 10, there is thus no mechanical or hydraulic coupling that necessarily converts an actuation of the brake pedal 17 into an actuation of the master brake cylinder 10. Accordingly, the brake system 8 is designed as a brake-by-wire brake system 8.

The motor vehicle 1 also has a device 18 for operating the brake system 8. The device 18 has a first control unit 19. The first control unit 19 is designed to control the first hydraulic actuator 14. The device 18 also has a second control unit 20. The second control unit 20 is designed to control the second hydraulic actuator 16. The control units 19 and 20 are connected to each other for communication.

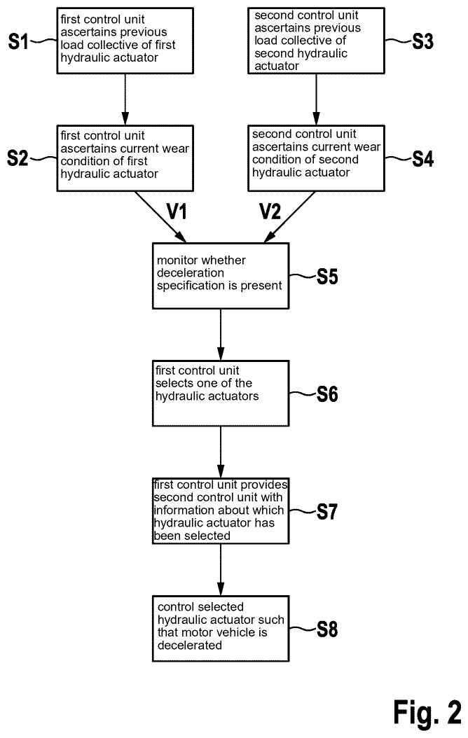

An advantageous method for operating the motor vehicle 1 is explained in more detail below with reference to FIG. 2. FIG. 2 shows the method with reference to a flow chart.

In a first step S1, the first control unit 19 ascertains a previous load collective of the first hydraulic actuator 14. Preferably, the first control unit 19 ascertains the load collective depending on a sensor signal from a pressure sensor (not shown), wherein the pressure sensor is designed to monitor the hydraulic pressure of the hydraulic fluid of the brake system 8. The first control unit 19 continuously ascertains the load collective so that a current load collective of the first hydraulic actuator 14 is always available. With regard to ascertaining the load collective of the first hydraulic actuator 14, various procedures are possible. For example, when ascertaining the load collective of the first hydraulic actuator 14, the first control unit 19 only takes into account loads that exceed a specified threshold load. Preferably, the first control unit 19 defines a plurality of load ranges and assigns each occurring load to one of the load ranges. When ascertaining the load collective, the various loads can then be weighted differently depending on their belonging to one of the load ranges.

In a second step S2, the first control unit 19 ascertains a current wear condition V1 of the first hydraulic actuator 14 depending on the load collective of the first hydraulic actuator 14. For this purpose, the first control unit 19 preferably first ascertains a deviation of the ascertained load collective from a specified maximum load collective. Depending on the deviation, the first control unit 19 subsequently ascertains the current wear condition V1 of the first hydraulic actuator 14.

In a third step S3, the second control unit 20 ascertains a previous load collective of the second hydraulic actuator 16. Preferably, the control unit 20 ascertains the load collective depending on the sensor signal of the pressure sensor. The second control unit 20 also continuously ascertains the load collective of the second hydraulic actuator 16 so that a current load collective of the second hydraulic actuator 16 is always available. Preferably, when ascertaining the load collective of the second hydraulic actuator 16, the second control unit 20 also only takes into account loads that exceed a specified threshold load. A different threshold load may be specified for the second hydraulic actuator 16 than for the first hydraulic actuator 14. However, the same threshold load may also be specified. Preferably, the second control unit 20 defines a plurality of load ranges and assigns each occurring load to one of the load ranges.

Depending on the load collective of the second hydraulic actuator 16, the second control unit 19 ascertains a current wear condition V2 of the second hydraulic actuator 16 in a fourth step S4. For this purpose, the second control unit 20 preferably first ascertains a deviation of the ascertained load collective from a specified maximum load collective. Depending on the deviation, the second control unit 20 subsequently ascertains the current wear condition V2 of the second hydraulic actuator 16. In step S4, the second control unit 20 also provides the first control unit 19 with information regarding the ascertained wear condition V2 of the second hydraulic actuator 16. According to a further exemplary embodiment, the second control unit 20 provides the first control unit 19 with information regarding the ascertained load collective of the second hydraulic actuator 16 or with information regarding the ascertained deviation. The first control unit 19 then ascertains therefrom the current wear condition V2 of the second hydraulic actuator 16. According to a further exemplary embodiment, the first control unit 19 ascertains the load collective of the second hydraulic actuator 16 and, therefrom, the current wear condition V2 of the second hydraulic actuator 16.

In a fifth step S5, it is monitored whether a deceleration specification is present for the motor vehicle 1. For example, the deceleration specification is present when the brake pedal 17 is actuated by the user of the motor vehicle 1. If it is determined that a deceleration specification is present, a sixth step S6 is referenced.

In the sixth step S6, the first control unit 19 then selects one of the hydraulic actuators 14 and 16. The first control unit 19 selects the hydraulic actuator 14 or 16 that is to be controlled in order to decelerate the motor vehicle 1 according to the present deceleration specification. When selecting one of the hydraulic actuators 14 and 16, the first control unit 19 takes into account the previously ascertained current wear conditions V1 and V2 of the hydraulic actuators 14 and 16. If one of the hydraulic actuators 14 or 16 has a lower wear condition than the other of the hydraulic actuators 14 and 16, the hydraulic actuator 14 or 16 with the lower wear condition is preferably or increasingly selected in step S6. Preferably, when selecting one of the hydraulic actuators 14 and 16, the first control unit 19 takes into account at least one further item of information in addition to the current wear conditions V1 and V2.

Preferably, the first control unit 19 makes the selection of one of the hydraulic actuators 14 and 16 depending on a target pressure build-up dynamics of the deceleration specification. If the target pressure build-up dynamics exceeds a threshold pressure build-up dynamics, the first control unit 19 preferably always selects the second hydraulic actuator 16. The second hydraulic actuator 16 designed as a radial piston pump 16 can typically generate a greater pressure build-up dynamics than the first hydraulic actuator 14. The selection is then made regardless of the current wear conditions V1 and V2 of the hydraulic actuators 14 and 16.

Alternatively or additionally, the first control unit 19 preferably makes the selection depending on a noise level in the passenger region of the motor vehicle 1. In particular, the noise level is detected by a microphone assigned to the passenger region and is provided to the first control unit 19. If the noise level in the passenger region of the motor vehicle 1 falls below a threshold noise level, the first control unit 19 preferably always selects the first hydraulic actuator 14. The first hydraulic actuator 14 typically generates less noise than the second hydraulic actuator 16 at the same volumetric delivery rate. If the noise level in the passenger region is low, the selection of the first hydraulic actuator 14 is advantageous.

Alternatively or additionally, the first control unit 19 preferably makes the selection depending on a detected actual temperature. For example, the first control unit 19 always selects the same hydraulic actuator if an actual temperature falls below a specified threshold temperature.

Preferably, the first control unit 19 checks the functional readiness of the hydraulic actuators 14 and 16 in step S6. If the first control unit 19 determines that one of the hydraulic actuators 14 and 16 is not functionally ready or is functionally ready only to a limited extent, the first control unit 19 always selects the other hydraulic actuator 14 or 16.

In a seventh step S7, the first control unit 19 provides the second control unit 20 with information about which of the hydraulic actuators 14 and 16 has been selected.

In an eighth step S8, the selected hydraulic actuator 14 or 16 is controlled such that the motor vehicle 1 is decelerated according to the deceleration specification. If the first hydraulic actuator 14 has been selected, the first control unit 19 controls the first hydraulic actuator 14 in step S8. However, if the second hydraulic actuator 16 has been selected, the second control unit 20 controls the second hydraulic actuator 16 in step S8.

By taking into account the current wear conditions V1 and V2 of the hydraulic actuators 14 and 16 when selecting one of the hydraulic actuators 14 or 16, the maximum service life of the hydraulic actuators 14 and 16 can be increased. It can in particular be avoided that one of the hydraulic actuators 14 and 16 wears out faster than the other of the hydraulic actuators 14 or 16.

In the method described with reference to FIG. 2, method steps S6 and S7 are carried out by the first control unit 19.

According to a further exemplary embodiment, these method steps are carried out by the second control unit 20. Accordingly, the second control unit 20 in this case selects one of the hydraulic actuators 14 and 16 and provides the first control unit 19 with information about which of the hydraulic actuators 14 and 16 has been selected.

1-13. (canceled)

14. A method for operating a motor vehicle including a hydraulic brake system having at least one controllable first hydraulic actuator and at least one controllable second hydraulic actuatorm, the method comprising the following steps:
ascertaining a current wear condition of the first hydraulic actuator;
ascertaining a current wear condition of the second hydraulic actuator is ascertained; and
decelerating the motor vehicle according to a deceleration specification by controlling a selected one of the first and second hydraulic actuators, wherein the selection of the one of the first and second hydraulic actuators is made depending on the ascertained wear conditions of the first and second hydraulic accelerators.

15. The method according to claim 14, wherein the wear condition of each hydraulic accelerator of the first and second hydraulic actuators is ascertained depending on an ascertained load collective of the hydraulic actuator.

16. The method according to claim 15, wherein a threshold load is specified, and only loads exceeding the threshold load are taken into account when ascertaining the load collective.

17. The method according to claim 15, wherein a plurality of load ranges are defined, and, when ascertaining each of the load collectives, occurring loads are weighted differently depending on their belonging to one of the load ranges.

18. The method according to claim 15, wherein a maximum load collective is specified, and the wear condition of each hydraulic accelerator of the first and second hydraulic accelerators is ascertained depending on a deviation of the ascertained load collective from the maximum load collective.

19. The method according to claim 14, wherein the selection of one of the first and second hydraulic actuators is made depending on a target pressure build-up dynamics of the deceleration specification.

20. The method according to claim 14, wherein a functional readiness of each of the first and second hydraulic actuators is checked, and the selection of the one of the first and second hydraulic actuators is made depending on the functional readiness of the first and second hydraulic actuators.

21. The method according to claim 14, wherein the selection of the one of the first and second hydraulic actuators is made depending on a noise level in a passenger region of the motor vehicle.

22. The method according to claim 14, wherein the selection of the one of the first and second hydraulic actuators is made depending on a detected actual temperature.

23. The method according to claim 14, wherein the selection of the one of the first and second hydraulic actuators is made depending on a specified target load ratio which describes a load to be applied by the first hydraulic actuator relative to a load to be applied by the second hydraulic actuator, and the target load ratio is specified depending on the ascertained wear conditions.

24. A device for operating a motor vehicle including a hydraulic brake system having at least one controllable first hydraulic actuator and one controllable second hydraulic actuator, comprising:
at least one control unit configured to:
ascertain a current wear condition of the first hydraulic actuator;
ascertain a current wear condition of the second hydraulic actuator is ascertained; and
decelerate the motor vehicle according to a deceleration specification by controlling a selected one of the first and second hydraulic actuators, wherein the selection of the one of the first and second hydraulic actuators is made depending on the ascertained wear conditions of the first and second hydraulic accelerators.

25. The device according to claim 24, wherein the at least one control unit includes a first control unit configured to control the first hydraulic actuator and a second control unit configured to control the second hydraulic actuator, wherein one of the first and second control units being configured to select the one of the first and second hydraulic actuators and to provide the other of the first and second control units with information regarding the selected one of the first and second hydraulic actuators.

26. A motor vehicle, comprising:
a hydraulic brake system including at least one controllable first hydraulic actuator and one controllable second hydraulic actuator; and
a device including at least one control unit configured to:
ascertain a current wear condition of the first hydraulic actuator;
ascertain a current wear condition of the second hydraulic actuator is ascertained; and
decelerate the motor vehicle according to a deceleration specification by controlling a selected one of the first and second hydraulic actuators, wherein the selection of the one of the first and second hydraulic actuators is made depending on the ascertained wear conditions of the first and second hydraulic accelerators.
